(19) United States
(12) Patent Application Publication
(10) Pub. No.: US 2015/0106144 A1
(43) Pub. Date: Apr. 16, 2015

(54) FIELD CREW MANAGEMENT SYSTEM AND METHOD

(71) Applicant: WAVSYS LLC, Brooklyn, NY (US)

(72) Inventors: Joshua Mangerson, Brooklyn, NY (US); John Rafferty, Key Biscayne, FL (US); Sean Yazbeck, Miami Beach, FL (US)

(73) Assignee: WAVSYS LLC, Brooklyn, NY (US)

(21) Appl. No.: 14/052,760

(22) Filed: Oct. 13, 2013

(51) Int. Cl. G06Q 10/06

(52) U.S. Cl. CPC G06Q 10/063114
USPC 705/7.15

(57) ABSTRACT

A field crew management system receives status reports at a management server from a plurality of field devices. The status reports can include information related to a work order associated with each field device. The status reports can be regularly updated during operational time of each work order. Once the status reports are received at the management server, a work order tracking sheet is populated with the information contained in the status reports. Progress reports based upon the work order tracking sheet are then generated for a requesting party at specified time interval and sent to the requesting party.

### BACKGROUND

The subject matter described herein relates to a field crew management system. In the telecommunications industry, building, updating and maintaining the telecommunications network is an ongoing process. Field crews are dispatched on a daily basis to work on and maintain the hardware and software of remote communication sites, e.g., off-site cell towers and related computing resources. During these work periods, parts of the communications networks are turned completely or partially off. The tracking of these outages is crucial to the telecommunications companies who are responsible for the equipment and for transmitting signals to end users of the telecommunication network.

The tracking of these field crews is difficult because the field crews consist of telecommunication company employees as well as outside contractors. These field crews can each be assigned specific tasks for a single cell tower. The specific tasks are usually completed in a specific order meaning one crew may not begin a work order until another crew completes its work order.

Currently, the responsibility for tracking crews is assigned to a crew manager in a brick and mortar facility, e.g., the offices of an outside contractor. The crew manager tracks a number of field crews under the contractors' control by making direct contact with a lead field technician of the field crew by telephone and maintaining a log of the work which the crew has completed or needs to complete as well as any issues that may arise, e.g., a shortage of supplies or work that needs to be performed by another field crew.

The crew manager makes a notation of the status of the field crews, tries to rectify any issues that arose or may arise and reports the status of the field crew work and the operational status of the cell tower to a liaison at the telecommunications company. Due to the large number of field crews working at any single moment, the task of tracking and updating the work of these crews is difficult and a crew manger usually does not have enough time to contact all field crews before an updated status report is needed by the company. Also, since the tracking of the field crews is so time consuming, many unforeseen issues that may arise do not get rectified in a timely manner.

### SUMMARY OF THE DISCLOSED TECHNOLOGY

The disclosed technology relates to a field crew management system. The field crew management system is used to track, manage, update status reports and prepare close-out packages for field crews and management teams. For example, when a field crew performs a scope of work (SOW) order at, e.g., a cell tower site of a telecommunications company, there are usually a number of tasks that must be completed by the field crews within a certain time frame. The field crew management system allows a management team of a contractor to track and manage the work of their field crews using a mobile field device.

In one implementation, a computer-implemented method comprises the steps of: receiving, at a management server, status reports from a plurality of field devices, the status reports including information related to a work order associated with each field device, the status reports being regularly updated during operational time of each work order; populating a work order tracking sheet with the information contained in the status reports; generating progress reports for a requesting party based upon the work order tracking sheet, the progress reports being generated at a specified time interval; and sending the progress reports to the requesting party. In some implementations, the specified time interval can be every two hours.

In other implementations, the status reports can be regularly updated at a start of each work order, every hour thereafter and at the end of each work order. Additionally, the status reports can include start of work reports, update reports and end of work reports where (1) the start of work reports can include time of arrival at a work site designated in the work order, location of the work site and any factors that affect work operations, (2) the update reports include any services that are disabled due to work operations and any factors that affect work operations and (3) the end of work reports include time of completion and any services that are to remain disabled due to work operations.

In another implementation, a system can comprise one or more processors and one or more computer-readable storage mediums containing instructions configured to cause the one or more processors to perform operations. The operations can include: receiving, at a management server, status reports from a plurality of field devices, the status reports including information related to a work order associated with each field device, the status reports being regularly updated during operational time of each work order; populating a work order tracking sheet with the information contained in the status reports; generating progress reports for a requesting party based upon the work order tracking sheet, the progress reports being generated at a specified time interval; and sending the progress reports to the requesting party.

In another implementation, a computer-program product can be tangibly embodied in a machine-readable storage medium and include instructions configured to cause a data processing apparatus to: receive, at a management server, status reports from a plurality of field devices, the status reports including information related to a work order associated with each field device, the status reports being regularly updated during operational time of each work order; populate a work order tracking sheet with the information contained in the status reports; generate progress reports for a requesting party based upon the work order tracking sheet, the progress reports being generated at a specified time interval; and send the progress reports to the requesting party.

The methods, systems and computer-program products allows a management team to prepare real-time or near-real-time progress reports for a contracting company in a timely manner as well as rectify any issues that need resolution in a quick and cost efficient manner.

### BRIEF DESCRIPTION OF THE DRAWINGS

FIG. 1 is a block diagram of an example of a management system used with the disclosed technology;

FIG. 2 is a flow chart showing an example process of the management system; and

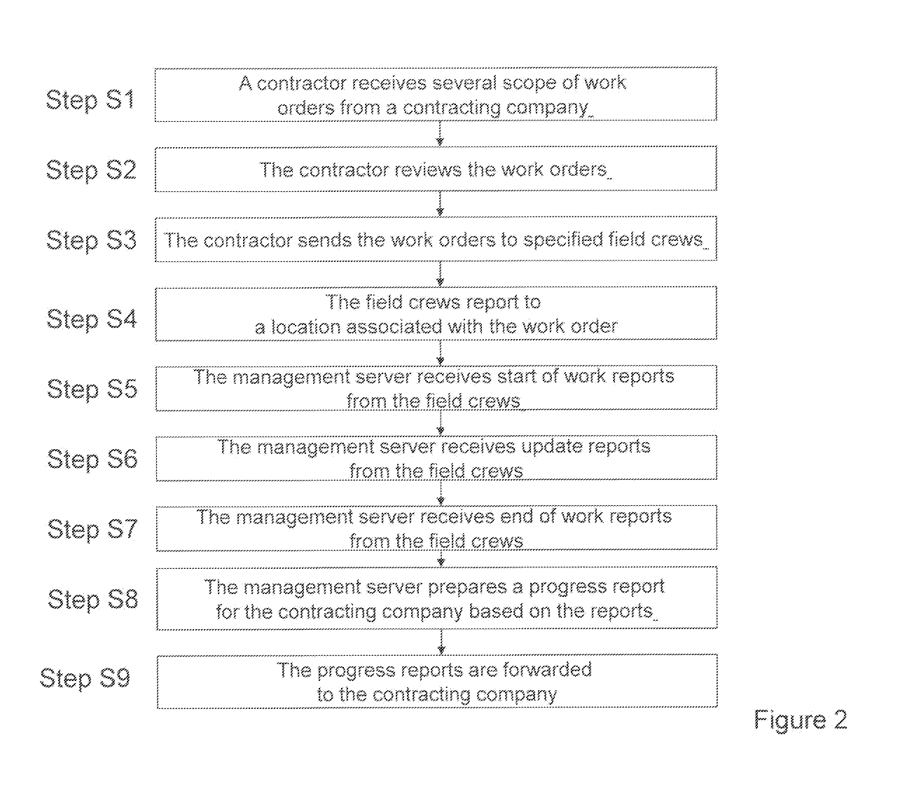

FIG. 3 is a flow chart showing an example process of the management server.

### DETAILED DESCRIPTION

The field crew management system is capable of delivering progress reports to a contracting company quickly and on demand in real time or near real time. This is accomplished by gathering real-time or near-real-time data related to off-site operations from field crews at a regularly scheduled time period. The site information can then be transmitted to a management server so that a management team can track, manage, update status reports and prepare close-out packages for SOW orders under their control, e.g., work orders assigned to the management team by the contracting company. Please note that the examples in this disclosure refer to the telecommunications industry but can be implemented in any industry where technicians perform field work.

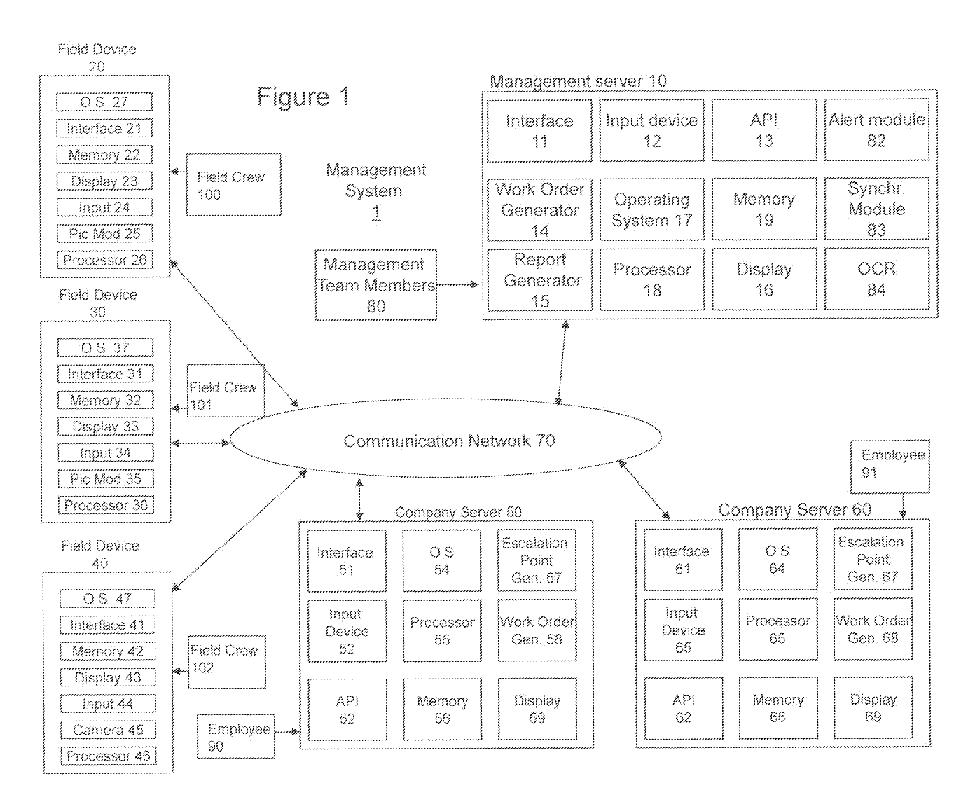

FIG. 1 illustrates a block diagram of an example of a field crew management system 1 that includes a management server 10, field crew devices 20, 30, 40 and contracting company servers 50, 60.

In some implementations, the field crew management system 1 can comprise one or more computer-based systems and/or human-based systems. The term “computer” is intended to include any data processing device, such as desktop computers, laptop computers, tablets, smartphones, mainframe computers, personal digital assistants, servers, mobile handheld devices, or any other device capable of processing data.

In some implementations, the management server 10 can be located on a single computer, as shown in FIG. 1, or on more than one communicatively connected computers. The term “communicatively connected” is intended to include any type of connection, whether wired or wireless, in which data may be communicated and is intended to include a connection between devices and/or programs within a single computer or between devices and/or programs on separate computers. The management server can include a display 16, operating system 17, processor 18, and memory 19.

In some implementations, a portion of the management server 10 can include human-based components where a user can, e.g., input data or instruct the components of the management system 1 to perform a task. In some implementations, a user interface 11 can be installed on the management server 10 so that management team members can access the management server 10 through the user interface 11 using an input device 12, e.g., a keyboard, a voice recognition device, a touch screen display, etc.

The management server 10 can also include an application programming interface (API) 13 that specifies how software components should interact with each other. The API can also specify a set of functions or routines that accomplish a specific task and how these functions or routines interact with specific software or hardware components of the management server 10.

The management server 10 can also include applications or programs accessible by different user groups, where the characteristics of the user group dictate the level, amount, and type of permissible access to the management server 10. For example, the users groups can include management team members 80, contracting company employees 90, 91 and field crew members 100, 101, 102. Each user group can access the management server 10 through an appropriate user interface 11, 21, 31, 41, 51, 61 which may be adapted or configured based on the particular user group. For example, the management team members 80 can be authorized to maintain, manage, monitor, supervise, or otherwise control the management server 10 while field crews 100, 101, 102 can be authorized to access the management server 10 for updating work order status and contracting companies employees 90, 91 can access the management server 10 to view progress reports.

In one implementation, the management server 10 can be installed on a centralized server and can reside in a secured facility. The management server 10 can be in communication with the field crew devices 20, 30, 40 and contracting company servers 50, 60 through a communication network 70. The communication network 70 facilitates communication between the various components of the management system 1. In some implementations, the communication network 70 can be a wired or wireless connection that can include the Internet, one or more intranets, and/or one or more bus subsystems. The communication network 70 can optionally utilize one or more standard communications technologies, protocols, and/or inter-process communication techniques.

The management server 10 can also include a work order generator 14, a report generator 15 and an alarm module 82. The management server 10 can also include a synchronizing module 83 for synchronizing data between the management server 10 and field crew devices 20, 30, 40 and the company servers 50, 60. In other words, the data stored on the management server 10 or the field crew devices 20, 30, 40 can be synchronized in real-time or near real time through the communication network 70 or the data stored on the management server 10 or the company servers 50, 60 can be synchronized in real-time or near real time through the communication network 70. This synchronization can be done automatically at specific time intervals or may be manually completed by, e.g., a field technician 100, 101, 102, a management team member 80 or a contracting company employee 90, 91.

In some implementation, the field devices 20, 30, 40 can be mobile data devices carried by a field crew member 100, 101, 102. The field devices 20, 30, 40 can include operating systems 27, 37, 47 processors, 26,36, 46, interfaces 21, 31, 41, memory 22, 32, 42, displays 23, 33, 43, input devices 24, 34, 44, and other functional components and combinations thereof. The field devices 20, 30, 40 can be any mobile device, e.g., portable personal computer systems, laptops, smart phones, tablets, etc. The field devices 20, 30, 40 can have appropriate software programs loaded onto the devices. For example, the field devices 20, 30, 40 can have an application dedicated to preparing work order forms, e.g., start of work, update status of work order, end of work and close-out packages.

The input devices 24, 34, 44 allow field technicians 100, 101, 102 to enter site information into the work order forms. This site information can include identifying information about the work site (e.g., physical address, cell tower ID number, global positioning system (GPS) coordinates or codes associated with the cell tower pre-stored on the field device), status of other work performed at the site (e.g., did another crew complete task needed for your work to begin), date and time work began and was completed and any other information deemed important for a particular work order. The input device can include a camera in combination with a picture module 25, 25, 45 so that photographs of the work site may be taken. This ensures that there is digital record of the work site at the start and end of a work order.

The work order forms can also include specific questions with a drop down menu giving pre-set answers. The forms may come in different types, e.g., start of shift, two-hour update, end of shift and work order completion. Other data that can be entered by the input devices 24, 34, 44 includes the name of the field technician working at the site. In some implementations, the information can be entered by scanning from an ID card(s) or site bar codes, when available. In some implementations, the field devices 20, 30, 40 can receive computerized work orders and the information from the work orders can be automatically entered into the work order forms.

In some implementations, several different contracting company servers 50, 60 can be part of the management system 1 and these different servers 50 60 may be stand-alone components in the respective company facility or the servers 50, 60 may be partitioned from the respective company's overall network. These company servers 50, 60 can comprise one or more computer-based systems and/or human-based systems. The servers 50, 60 can be located on a single computer or on more than one communicatively connected computers. The servers can include operating systems 54, 64, processors, 55, 65, memory, 56, 66, and displays 59 and 69.

In some implementations, a user interface 51, 61 can be installed on the servers 50, 60 so that contracting company employees 90, 91 can access the management server 10 through the user interface 51, 61 using an input device 52, 62, e.g., a keyboard, voice recognition device, touch screen display, etc. The access can be restricted based upon parameters set by the management team 80. The company servers 50, 60 can also include an application programming interface 53, 63 (API) that specifies how software components of the company server 50, 60 and the management server 10 may interact with each other.

The servers 50, 60 can also include a SOW order generator 58, an escalation point generator 57. The SOW order generator 58 can generate work orders for a contractor and can transmit the work order from the company server 50, 60 to the management server 10. The work orders can include explicit instructions of the type of work to be performed and the time frame it can be expected to be completed.

The escalation generator 57 can create escalation points based on the SOW order. Escalation points define attributes that trigger an action. For example, if a work order is not completed within a defined time period, an escalation can be generated, or if a work order cannot begin because of some inaction, an escalation can be generated. Once an escalation point is triggered, a notification can be created to notify a contractor of an escalation. In one example, a telecommunication company may want to upgrade a cell tower with new equipment. This entails getting a first contractor to deliver equipment needed for the upgrade to the cell site. A second contractor may be in charge of running new wiring from the cell site computing resources to the cell tower transmitters while a third crew may install the new computing resources. The synchronization of these separate work orders can often cause delays to the work being completed. This in turn causes a cell tower to be put out of service partially or completely for longer than anticipated by the telecommunications company. The telecommunications company wants to minimize the time that a site is off the air so it requires regular updates, e.g. every two hours, with all outside contractors involved with the cell site. If work is not completed within a set period of time, the escalation point is triggered. For example, escalation points can be created for time elapsed between an event (e.g., a start time for a work order) and the current date and time. If one part of the project is not completed and an escalation point is triggered, the server can send a message to the contactor informing them of the delay.

In some implementations, the data stored on the management server 10 can be synchronized in real-time or near real time with a memory 56, 66 associated with the company server 50, 60 by the synchronizing module 83. This synchronization can be done automatically at specific time intervals or may be manually completed by, e.g., a management team member 80.

In some implementations, a management server 10 can receive a scope of work (SOW) or a work order directly from a company server 50, 60. The scope of work or work order can describe the work that must be done in detail and specifies the hardware and software involved and the exact nature of the work to be done. In this implementation, the work order can be processed by the management server 10 and stored in a memory 19. The term “memory” is intended to include any data structure, computer-accessible data storage device or database, whether volatile or nonvolatile, electronic, optical, or otherwise.

In other implementations, the scope of work or work order can be received by the management team 80 as an e-mail, a facsimile, or any other method of receipt and the work order can be manually inputted into the management server 10 or scanned into the server using an optical recognition device 84. In another implementation, the work order can be received by the management team 80 as an e-mail, a facsimile, or any other method of receipt and the work order can be directly sent to a field crew 100, 101, 102 through the management server 10 or the work order can be scanned and transmitted to the field device 20, 30, 40 or the work order can be manually handed to a member 100, 100, 101 of the field crew as a paper document. In any of the cases, the management team 80 receives the work order and assigns a field crew to the work order for completion. In some implementations, alarms can be set on the management server 10 so that if a field crew does not acknowledge receipt of a work order or a work order does not start within a specified time frame or a work order is not completed within a specified time, the management team can get an immediate notification. The notification can be a message sent to a team member 80 or a visual alert on a display 16. In some implementations, the management team 80 can verify the location of field crew 100, 101, 102 using a GPS tracking device installed on the field devices 20, 30, 40.

In return for assigning the work order to the field crew, the server 10 receives a start of work form from the field crew. The start of work form details the progress of the work order form with a start time, site location and any other information pertaining to the work to be performed within the work order. The server 10 can also receives from the field crew update work forms, end of work forms and completion forms.

The work forms may also contain alerts informing the server that issues arose upon arriving at the site, e.g., any work that needed to be performed before the work can start was not completed or if any equipment needed for the work order is not on site.

The work forms can be processed by the server 10 and uploaded in a work order tracking sheet. In some implementations, the data from the work forms are transformed into a spreadsheet, e.g., an Excel spreadsheet, and in other implementations, the data from the work forms are loaded into a database structure 19 and than uploaded to a work order tracking sheet.

In either case, the work order tracking sheet shows all current work orders and their status. If a particular work order is in alert mode, e.g., work did not begin on time, is behind schedule or needs attention, the particular work order can be color-coded to visually indicate the alert. The work order tracking sheet is updated each time a work form is received from a field crew.

The management team 80 may review the data sheet at any time. During their reviews, the management team 80 can send notifications to field crews regarding alerts. Also, the management team 80 can prepare progress reports for the company. In some implementations, the progress report can be automatically generated and transmitted to a data structure 56, 66 within the company server 50, 60. In other implementations, a member of the company 90, 91 can log into the server 10 and review the work order tracking sheet as it exists on the management server 10 or the server 10 can transform the work order tracking sheet into a progress report document for company review.

In some implementations, the management team 80 can sort the work order tracking sheet and send the customer the real-time updates. For example, the management team 80 can manually take a snap shot of the spreadsheet and sends it to the company. The snap shot can be limited to certain fields as requested by the company. In another implementation, the management team 80 may compile a high level dashboard from the spreadsheet. For example, the dashboard can be a document informing the company that “Of the 20 sites we are working on: 1 can not be started because inventory showed missing cable, 2 are 100% complete with no issues, 5 are in progress on all technologies with all off the air, 10 are still off the air on all technologies because we are waiting for the tower crew complete their SOW, 2 are complete on GSM and UMTS only, but LTE is still off the air”.

In some implementations, a team member 80 can submit a request for a report to a report generator 15. Based on the type of report request, the report generator 15 can retrieve appropriate information from the data structure 19, generate the report, and provide the report to the requesting team member. In some implementations, the report generator 15 can be configured to automatically run reports at one or more specific intervals of time (e.g., hourly) according to a pre-determined and customizable schedule. For example, the report generator 15 may run a report every two hours detailing the status of each work order and automatically deliver the report to the company server 50, 60.

In some implementations, the company server 50, 60 can create work orders (Step T1) and escalation points. (Step T2). The work orders can be transmitted to the management server 10 (Step T3). The company server 50, 60 can also receive progress reports on timed basis. Once progress reports are received, the progress report can be compared to the escalation points created by the company server 50, 60. If an escalation point is triggered, the company server 50, 60 can send an escalation notice to the management team 80. (Step T4). For example, if a work order becomes past due because one field crew may not have completed their task before another field crew shows up, a reminder is sent to the first crew to complete their work order.

In FIG. 1, the field crews 100, 101, 102 can receive a work order on a field device 20, 30, 40 though the management server 10. Once received, the field device 20, 30, 40 can automatically create a work order form for the work order and begin to ask a crew member a series of questions regarding the work site conditions and any other discernable information about the site. In another implementation, the field crew can log onto the server through the field device when the field crew arrives at a work site and begin to answer a series of questions regarding the work site conditions and any other discernable information about the site. In another implementation, a field crew may have a paper copy of a work order and when arriving at the work site, input into the field device, a time of arrival and other work site information.

In any of these cases, the field device will prompt a field technician with a series of queries, e.g., what is the status of the cell site, was the site functioning properly, can you proceed with your work order. These queries can change depending on the scope of work order. In return, the crew member will answer the questions using, e.g., a drop down screen having standard, pre-set answers. In one example, Adobe Forms Central can be used to create the “Ask Yourself Questions” for the work forms. In some implementations, pictures can be taken and stored in a data structure 22, 32, 42 associated with the field device 20, 30, 40, e.g., an internal memory or an external memory. The pictures can be: stored with pre-set names, compressed into a folder to be e-mailed, uploaded to a work order from or put into an external data structure, e.g. an online data repository.

The crew member can also set alerts notifying the management team of any problems that occurred or may occur at the work site which may inhibit their work flow. Once complete, the start of work form is transmitted to the management server.

At scheduled times, the field crew member can be asked to complete update forms. In some implementations, the field crew member can be notified of an update request by setting alarms in the field device. In some cases, the field crew member may be required to complete the update report and submit it every two hours so there are updates in real time. Once the work for the work order has ended, the field crew member is asked to complete an end of work forms. Also, at the end of the work, the field crew member may be asked to complete a close-out package.

In some implementations, the end of work form can also act as the close-out package that can be submitted to the company detailing that the work order was completed. Accordingly, the management team does not have to manually gather all of the pieces together into a package and submit it to the client. By making the field crew member build the report in a standard model and submit it to the management team, twice the output is achieved. Once the field crew member has given the update at the end of the shift, the close-out package is put in a proper form to submit to the contracting company for payment. This close-out package can include specific pictures with a specific naming convention that must be completed and submitted with whatever other check lists, inventory lists, screenshots etc. are mandated by the SOW.

In some implementations, a picture module 25, 35, 45 can allow the field crew member to take the required pictures in the order needed. The picture module 25, 35, 45 can name the pictures automatically using a naming convention and upload the pictures to a data structure, e.g., a “dropbox” of an online data repository. This module 25, 35, 45 ensures that all pictures have the proper naming convention, all pictures needed for the SOW are taken, and simplifies the task for the field technician so that the field team may finish at a site faster which, in turn, saves time and money. The field technician then completes the close out report, attaches the pictures that are already named in the dropbox and submits the close out package to management team 80.

In one example, an outside contactor receives several scope of work (SOW) orders from a contracting company. (Step S1). The SOW order can be transmitted by any known method, e-mail, fax, phone, etc. The SOW order can include the work that the contracting company is requesting of the outside contactor as well as a description of other tasks that must be performed by other parties before work on the SOW order begins. The outside contractor can review the work order (Step S2) and send the work orders to specified field crews (Step S3). The work orders can be transmitted to the field crews through a wireless communications network or may be physically handed to the field crews at a crew station.

The field crews, after receiving their particular work order, report to the location associated with the work order, e.g., cell tower A. (Step S4). At time of arrival, the field crew will report its arrival time through their field crew device, complete a start of work report and send the report to the management server. (Step S5). The start of work report can include information such as time and date of arrival, status of the site, were alarms present, can you begin work, did other crews complete work (i.e., other contractor's status and does it affect our work), inventory needed on scene, and any other questions that will make the work order successful. These questions can change depending on the scope of work for each work order.

At certain time intervals, the field crew can also complete update reports and send the reports to the management server. (Step S6). The update reports can include, e.g., are any services turned off, is work order being completed within specified time frame, is anything requested for completion.

At the completion of the work order, the field crew can complete an end of work report and send the reports to the management server. (Step S7). The end of work report can include the time the work was completed and the on/off status of any services after completion.

These reports are received by the management server and the management server uses these reports to prepare a progress report for the contracting company. (Step S8). The progress reports can include, e.g., the number of work orders pending, the number of work order completed, the status of each work order, any problems that arose with a particular work order, services that are on or off at a particular work site and any other information that is of interest to the contracting company. These progress reports can be prepared at a time interval chosen by the contracting company, e.g. every two hours. Once prepared, the progress reports are forwarded to the contracting company for their review. (Step S9).

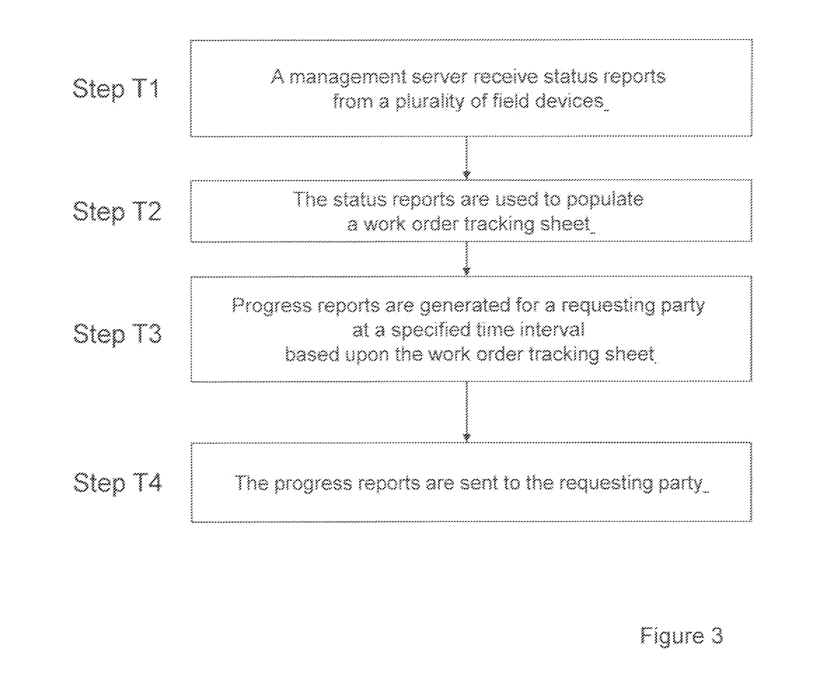

In another example shown in FIG. 3, a management server 10 can receive status reports from a plurality of field devices 20, 30, 40. (Step T1). The status reports can include information related to a work order associated with each field device. These status reports can be updated regularly during operational time of each work order. Once received, the information in the status reports is used to populate a work order tracking sheet. (Step T2). Progress reports are then generated for a requesting party at a specified time interval based upon the work order tracking sheet. (Step T4). The progress reports are sent to the requesting party. (Step T4).

It is noted that the systems and methods disclosed herein may be implemented on various types of computer architectures, such as for example on a single general purpose computer or workstation, or on a network (e.g., local area network, wide area network, or internet), or in a client-server configuration, or in an application service provider configuration. Also, the system's and method's data (may be stored as one or more data structures in computer memory and/or storage depending upon the application at hand. The systems and methods may be provided on many different types of computer readable media including instructions being executable by a computer to perform the system and method operations described herein. The systems and methods may also have their information transmitted via data signals embodied on carrier signals (e.g., radio frequency carrier signals) or other communication pathways (e.g., fiber optics, infrared, etc.).

The computer components, software modules, functions and data structures described herein may be connected directly or indirectly to each other in order to allow the flow of data needed for their operations. It is also noted that a module includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The computer components may be located on a single computer or distributed across multiple computers depending upon the situation at hand.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A computer-implemented method comprising the steps of:
receiving, at a management server, status reports from a plurality of field devices, the status reports including information related to a work order associated with each field device, the status reports being regularly updated during operational time of each work order;
populating a work order tracking sheet with the information contained in the status reports;
generating progress reports for a requesting party based upon the work order tracking sheet, the progress reports being generated at a specified time interval; and
sending the progress reports to the requesting party.

2. The method of claim 1 wherein the status reports are regularly updated at a start of each work order, every hour thereafter and at an end of each work order.

3. The method of claim 1 wherein the status reports include start of work reports, update reports and end of work reports.

4. The method of claim 3 wherein the start of work reports include time of arrival at a work site designated in the work order, location of the work site and any factors that affect work operations.

5. The method of claim 3 wherein the update reports include any services that are disabled due to work operations and any factors that affect work operations.

6. The method of claim 3 wherein the end of work reports include time of completion and any services that are to remain disabled due to work operations.

7. The method of claim 1 wherein the specified time interval is every two hours.

8. A system comprising:
one or more processors;
one or more computer-readable storage mediums containing instructions configured to cause the one or more processors to perform operations including:
receiving, at a management server, status reports from a plurality of field devices, the status reports including information related to a work order associated with each field device, the status reports being regularly updated during operational time of each work order;
populating a work order tracking sheet with the information contained in the status reports;
generating progress reports for a requesting party based upon the work order tracking sheet, the progress reports being generated at a specified time interval; and
sending the progress reports to the requesting party.

9. The system of claim 8 wherein the status reports are regularly updated at a start of each work order, every hour thereafter and at an end of each work order.

10. The system of claim 8 wherein the status reports include start of work reports, update reports and end of work reports.

11. The system of claim 10 wherein the start of work reports include time of arrival at a work site designated in the work order, location of the work site and any factors that affect work operations.

12. The system of claim 10 wherein the update reports include any services that are disabled due to work operations and any factors that affect work operations.

13. The system of claim 10 wherein the end of work reports include time of completion and any services that are to remain disabled due to work operations.

14. The system of claim 8 wherein the specified time interval is every two hours.

15. A computer-program product, the product tangibly embodied in a machine-readable storage medium, including instructions configured to cause a data processing apparatus to:
receive, at a management server, status reports from a plurality of field devices, the status reports including information related to a work order associated with each field device, the status reports being regularly updated during operational time of each work order;
populate a work order tracking sheet with the information contained in the status reports;
generate progress reports for a requesting party based upon the work order tracking sheet, the progress reports being generated at a specified time interval; and
send the progress reports to the requesting party.

16. The computer-program product of claim 15 wherein the status reports are regularly updated at a start of each work order, every hour thereafter and at an end of each work order.

17. The computer-program product of claim 15 wherein the status reports include start of work reports, update reports and end of work reports.

18. The computer-program product of claim 17 wherein the start of work reports include time of arrival at a work site designated in the work order, location of the work site and any factors that affect work operations.

19. The computer-program product of claim 17 wherein the update reports include any services that are disabled due to work operations and any factors that affect work operations.

20. The computer-program product of claim 17 wherein the end of work reports include time of completion and any services that are to remain disabled due to work operations.
